(19) United States
(12) Patent Application Publication
(10) Pub. No.: US 2008/0011390 A1
(43) Pub. Date: Jan. 17, 2008

(54) Galfenol steel

(76) Inventors: Arthur E. Clark, Adelphi, MD (US); Marily Wun-Fogle, Potomac, MD (US); Thomas A. Lograsso, Ames, IA (US)

Correspondence Address: OFFICE OF COUNSEL, CODE 004;NAVAL SURFACE WARFARE CENTER, CARDEROCK DIVISION, 9500 MACARTHUR BLVD., WEST BETHESDA, MD, 20817, US

(21) Appl. No.: 11/822,778

(22) Filed: Jul. 10, 2007

Related U.S. Application Data
(60) Provisional application No. 60/832,007, filed on Jul. 11, 2006.

(51) Int. Cl. H01F 1/01

(52) U.S. Cl. 148/306

(57) ABSTRACT

A magnetostrictive alloy containing iron and gallium comprising:

Fe_{100-(x+y+z)}GaₓAl_{y}C_{z};
where x is of from about 5 at. % to about 30 at. %;
where x+y is of from about 5 at. % to about 30 at. %; and
where z is of from about 0.005 at. % to about 4.1 at. %. The alloys can also contain B and N.

### CROSS-REFERENCE TO RELATED APPLICATIONS

This application claims the benefit of U.S. Provisional Application No. 60/832,007, filed Jul. 11, 2006, which is incorporated herein by reference.

### STATEMENT OF GOVERNMENT INTEREST

The following description was made in the performance of official duties by employees of the Department of the Navy, and, thus the claimed invention may be manufactured, used, licensed by or for the United States Government for governmental purposed without the payment of any royalties thereon.

### TECHNICAL FIELD

The following description relates generally to magnetostrictive iron and gallium containing alloys, containing carbon, boron and/or nitrogen and, possibly Al. More particularly, iron and gallium containing alloys, with or without Al, in which the iron source can be pure iron, low carbon steel, high carbon steel or mixtures thereof, and the carbon source can be pure carbon, low carbon steel, high carbon steel and mixtures thereof. These alloys can contain boron and/or nitrogen. These alloys can be used in magnetomechanical actuators, e.g., sonar transducers, ultrasonic transducers, and active vibration reduction devices.

### SUMMARY

A magnetostrictive iron and gallium containing alloy has a formula:

Fe_{100-(x+y+z)}GaₓAl_{y}C_{z}

in which x is of from about 5 at. % to about 30 at. %; x+y is of from about 5 at. % to about 30 at. %; and z is of from about 0.005 at. % to about 4.1 at. %.

Another preferred embodiment of the magnetostrictive iron and gallium containing alloy has a formula:

Fe_{100-(x+y+z)}GaₓAl_{y}B_{z}

in which x is of from about 5 at. % to about 30 at. %; x+y is of from about 5 at. % to about 30 at. %; and z is of from about 0.005 at. % to about 4.1 at. %.

Another preferred embodiment of the magnetostrictive iron and gallium containing alloy has a formula:

Fe_{100-(x+y+z)}GaₓAl_{y}N_{z};

in which x is of from about 5 at. % to about 30 at. %; x+y is of from about 5 at. % to about 30 at. %; and z is of from about 0.005 at. % to about 4.1 at. %.

### BACKGROUND

Magnetostrictive iron-gallium alloys are called Galfenol. Galfenol is an interesting material because of both its high magnetostriction and its desirable mechanical properties. The magnetostriction can be as high as 400 ppm in single crystals and 250 ppm in textured polycrystals. Fe—Ga is mechanically strong and can support tensile stresses up to 500 MPa, unlike current active materials, e.g., Terfenol-D, lead zirconic titantate (PZT), and lead magnesium niobate (PMN). Fe—Ga alloys can also be machined and welded with conventional metal-working techniques unlike current active materials, e.g., Terfenol-D, PZT and PMN. Another property of the alloys is that after annealing under a compressive stress, Galfenol alloys maintain full magnetostrictions when subjected to as much as 50 MPa of applied tensile stresses. The cost of the iron-gallium alloys, using pure Fe and pure Ga as the starting elements, is high. The primary objectives of the invention are: to decrease the cost of Galfenol, improve the magnetostrictive properties of Galfenol and improve the strength of Galfenol.

Pure Fe and pure Ga are expensive. It is desirable to increase the efficiency in manufacturing the alloys containing Fe and Ga in either the single crystal manufacturing process and/or the polycrystalline manufacturing process by decreasing purchasing costs of the starting materials, decreasing the number of preparation steps in the manufacturing processes and/or adding formability of the alloy.

It is also desirable to increase the value of the saturation magnetostriction of the alloy, commonly expressed by ( 3/2)λₛ or ( 3/2)λ₁₀₀, since the amount of work that can be performed by the alloy is directly proportional to the saturation magnetostriction. For many of the highly magnetostrictive alloys of Fe₁₀₀₋ₓGaₓ (17<x<22), a higher peak in the saturation magnetostriction was found when the samples were quenched than when the samples were slow cooled (furnace cooled) in the preparation process. It is desirable to develop alloy preparation techniques in which the value of the saturation magnetostrictions of the new alloys prepared by the slow cooled (furnace cooled) method achieve values close to or greater than those of the prior quenched alloys.

For applications in which the alloys may undergo tensile stresses, for example, those encountered in shock environments, it is important to improve the tensile strength of the alloys. It is well known that steel composed of Fe plus C, e.g., low carbon steel, has a higher tensile strength than of pure Fe.

B and N are both small atoms like C. Many features of C additions listed above may be realized by B and N additions to the binary iron-gallium alloy.

### BRIEF DESCRIPTION OF THE DRAWINGS

Other features will be apparent from the description, the drawings, and the claims.

FIG. 1 is a graph that illustrates how the saturation magnetostriction, ( 3/2)λ₁₀₀, depends upon the atomic percent of Ga in the iron-gallium alloy when the alloy is slow cooled or quenched during the manufacturing process and when C is added and the alloy is slow cooled during the manufacturing process;

FIG. 2 is a graph that illustrates how the saturation magnetostriction, ( 3/2)λ₁₀₀, depends upon the atomic percent of Ga in the iron-gallium alloy when the alloy is slow cooled or quenched during the manufacturing process and when B is added and the alloy is slow cooled during the manufacturing process; and

FIG. 3 is a graph that illustrates how the saturation magnetostriction, (3/2)λ₁₀₀, depends upon the atomic percent of Ga in the iron-gallium alloy when the alloy is slow cooled or quenched during the manufacturing process and when N is added and the alloy is slow cooled during the manufacturing process.

### DETAILED DESCRIPTION

Galfenol are highly magnetostrictive alloys that can be prepared as single crystals or polycrystals.

A preferred embodiment of the composition has the formula:

Fe_{100-(x+y+z)}GaₓAl_{y}C_{z};

where x is of from about 5 at. % to about 30 at. %; where x+y is of from about 5 at. % to about 30 at. %; and where z is of from about 0.005 at. % to about 4.1 at. %. B can be added to this composition in amounts of from about 0.005 at. % to about 4.1 at. %, N can be added this composition in amounts of from about 0.005 at. % to about 4.1 at. % and both B and N can be added to this composition in the same at. % range.

In this preferred embodiment, iron-gallium (Galfenol) alloys are prepared as single crystals or polycrystals having C as an ingredient. There are at least 4 sources of Fe. They are: pure iron, low carbon steel, high carbon steel and mixtures thereof. It is recognized that the low carbon steel and high carbon steel have impurities, e.g., Si, S, Mn, P, Ni, Mo and Cr.

There are at least four possible sources of carbon. They are pure carbon, low carbon steel, high carbon steel, and mixtures thereof. Graphite is a source of the pure carbon. When the source of carbon is from the low carbon steel and/or the high carbon steel, the carbon steel can be used along with pure Fe as the Fe portion of the alloy in addition to being the carbon source. The C addition, when obtained from low cost steel, has the highly desired quality of decreasing the cost of the starting materials. Pure Fe is more expensive than Fe+C in the form of steel.

The procedure for determining the concentration of each element is standard for one skilled in the art of alloy making. Thus, low carbon steel and/or high carbon steel is a source of some or all of the Fe and possibly all of the carbon.

In the prepared samples, a portion of Fe in the iron-gallium alloy is replaced with Fe+C, in the form of low carbon steel. It is theorized that atoms of the small element, C, do not replace Fe or Ga (large atoms) in the crystalline lattice of the alloy, but locate at interstitial positions (between the larger atoms) in the alloy. C in these positions stabilizes the higher magnetostrictive disordered iron-gallium phase. For binary alloys with Ga concentrations>17%, the cheaper slow cooling (furnace cooling) preparation technique tends to yield an alloy in the lower magnetostrictive ordered phase. With the C additions, the higher magnetostrictive phase is obtained by the cheaper slow cooling technique. Consequently, there is no need for the additional quenching technique to obtain the preferable higher magnetostriction which adds cost to the manufacturing of the alloy.

Another preferred embodiment of the composition has the formula:

Fe_{100-(x+y+z)}GaₓAl_{y}B_{z};

where x is of from about 5 at. % to about 30 at. %; where x+y is of from about 5 at. % to about 30 at. %; and where z is of from about 0.005 at. % to about 4.1 at. %.

There are at least three possible sources of boron. They are pure boron and iron borides, and mixtures thereof. Additionally, a master alloy made from pure iron and pure boron may be used as the source of boron. The master alloy may contain up to 10 at. % B and is pre-alloyed prior to being used as an additive to the Fe—Ga alloys. The iron source, e.g., low carbon steel and/or high carbon steel, may contain carbon.

Another preferred embodiment of the composition has the formula:

Fe_{100-(x+y+z)}GaₓAl_{y}N_{z};

where x is of from about 5 at. % to about 30 at. %; where x+y is of from about 5 at. % to about 30 at. %; and where z is of from about 0.005 at. % to about 4.1 at. %.

The source of nitrogen are iron nitride (FeN).

The most inexpensive source of aluminum is pure aluminum as it is readily available in pure form. Al may or may not be added to the Fe—Ga—C alloy with Ga in amounts of from 5 at. % to 30 at. %.

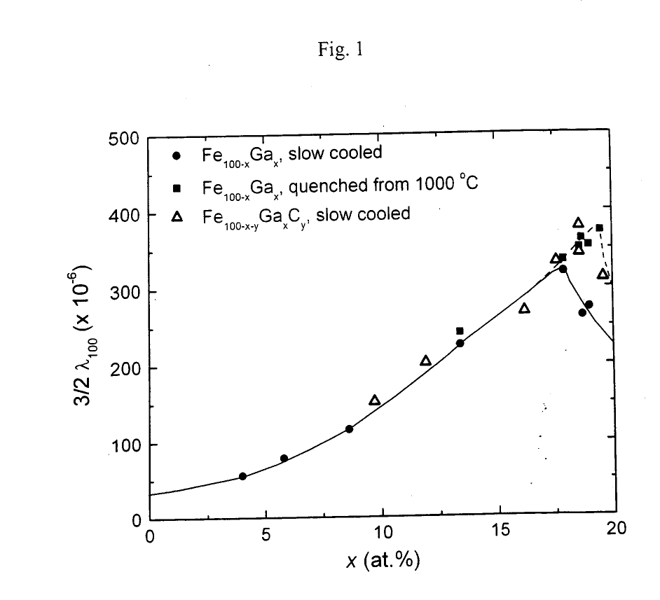

FIG. 1 illustrates how the saturation magnetostriction, ( 3/2)λ₁₀₀, depends upon the atomic percent of Ga in the iron-gallium alloy. Percentages are shown up to 20 at. % Ga. In this figure, ( 3/2)λ₁₀₀ denotes the fractional change in length of the alloy as an external applied magnetic field is rotated from perpendicular to parallel to a particular ([100]) measurement direction. The black circles in the figures indicate the values found for samples prepared in prior work by the slow cooled (furnace cooled) method, the black squares indicate the values found for samples prepared in prior work by the quenching method. The triangles in the figures indicate the values found for samples containing Fe, Ga, and C and slow cooled during the manufacturing process. For the very important high magnetostriction alloys, Fe₁₀₀₋ₓGaₓ with x>17 at. % Ga, the saturation magnetostriction exceeded 300 ppm. It was found that for the high Ga concentration alloys, prepared by slow cooling with C included in the starting material, Fe_{100-(x+y)}GaₓC_{y} with x>17 at. %, the magnetostriction exceeded the values of those prepared in prior work by the slow cooling method and was near those of the binary alloy, Fe₁₀₀₋ₓGaₓ, using the quenching technique. In particular the Fe_{100-(x+y)}GaₓC_{y} alloy with x=18.6 at. %, the magnetostriction exceeded that of the binary alloy by approximately 35%.

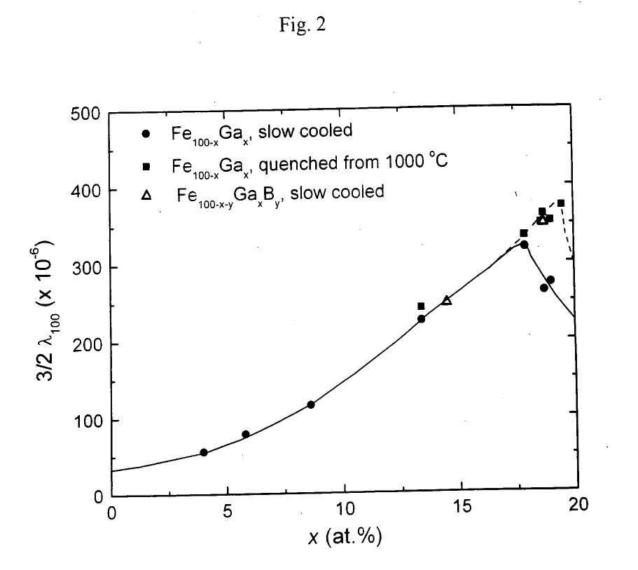

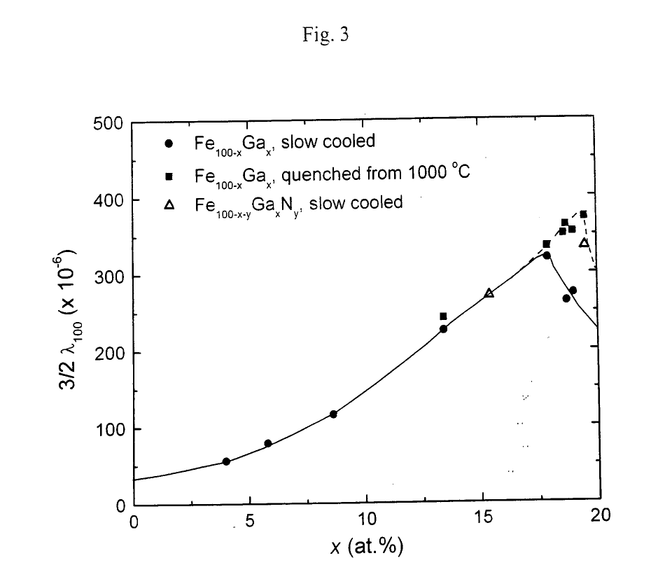

In FIG. 2, the addition of B to the binary FeGa alloys demonstrates similar results as the carbon addition in FIG. 1. In particular, the Fe—Ga—B alloy with x=18.7 at. %, the magnetostriction exceeded that of the binary alloy by approximately 27%. Either low carbon or high carbon steel was used in the making of the Fe—Ga—B alloys. In FIG. 3, the addition of N to the binary alloys demonstrates similar results as the carbon addition in FIG. 1. In particular, the Fe—Ga—N alloy with x=19.5 at. %, the magnetostriction exceeded that of the binary alloys by approximately 38%, as shown in FIG. 1. Either low carbon or high carbon steel was used in the making of the Fe—Ga—N alloys.

Single crystals were grown by the Bridgman technique using a resistance heated furnace. Appropriate quantities of starting materials for the desired composition were cleaned and arc melted several times under an argon atmosphere. The buttons were then removed and the alloy drop cast into a copper chill cast mold to ensure compositional homogeneity throughout the ingot. The as-cast ingot was placed in an alumina crucible and heated under a vacuum to 900° C. After reaching 900° C., the growth chamber was backfilled with ultra-high purity argon to a pressure of 1.03×10⁵ Pa. This over-pressurization is necessary in order to maintain stoichiometry. Following pressurization, heating was continued until the ingot reached a temperature of 1600° C. and held for 1 hour before being withdrawn from the furnace at a rate of 4 mm/hr. The ingot was annealed at 1000° C. for 168 hours (using heating and cooling rates of 10 degrees. The ingot is considered to be in the “slow cooled” state after this annealing process. Quenched samples were obtained by holding the slowed cooled samples at 1000° C. for an additional 4 hours and then plunged into water.

To yield the highest saturation magnetostriction, the crystal should be oriented such that the measurement direction is along the [100] crystalline direction. Oriented single crystals were sectioned from the larger single crystal ingots for magnetic and strain gage measurements. ( 3/2)λ₁₀₀ denotes the fractional length change when the magnetic field is rotated 90°, from perpendicular to parallel to the measurement direction, and is the largest length change that can be achieved by the alloy. It is preferable to prepare polycrystals textured such that a predominance of the [100] crystalline directions lie along the measurement direction.

The following Tables of Data provide examples of ternary alloys containing Fe, Ga, C, B and N, where the magnetostriction value was measured by standard strain gage techniques. Magnetostriction was measured using the angular measurements method with the strain gage along the [100] direction. The magnetostriction values are a single measurement or an average of 2 or more measurements from the same alloy. The source of Fe might provide some amount of C to the B and N alloys.

| | |
|---|---|
| | Magnetostriction (ppm) |
| | @H = 20 kOe |
| Composition | (Slow cooled) |

FeGaC Data

| | |
|---|---|
| Fe_{82.33}Ga_{17.6}C_{0.07} | 332 |
| Fe_{81.33}Ga_{18.6}C_{0.07} | 378 |
| Fe_{81.23}Ga_{18.6}C_{0.17} | 343 |
| Fe_{83.72}Ga_{16.2}C_{0.08} | 268 (@H = 15 kOe) |
| Fe_{90.14}Ga_{9.7}C_{0.16} | 152 |
| Fe_{87.94}Ga_{11.9}C_{0.16} | 202 |
| Fe_{80.37}Ga_{19.6}C_{0.03} | 311 |
| Fe_{80.47}Ga_{19.5}C_{0.03} | 321 |

FeGaN Data

| | |
|---|---|
| Fe_{84.59}Ga_{15.4}N_{0.01} | 270 |
| Fe_{80.49}Ga_{19.5}N_{0.01} | 334 |

FeGaB Data

| | |
|---|---|
| Fe_{85.48}Ga_{14.5}B_{0.02} | 247 |
| Fe_{81.22}Ga_{18.7}B_{0.08} | 350 |

A number of exemplary implementations have been described. Nevertheless, it will be understood that various modifications may be made. For example, suitable results may be achieved if the steps of the described techniques are performed in a different order and/or if components in a described component, system, architecture, or devices are combined in a different manner and/or replaced or supplemented by other components. Accordingly, other implementations are within the scope of the following claims.

What is claimed is:

1. A magnetostrictive alloy containing iron and gallium comprising:
Fe_{100-(x+y+z)}GaₓAl_{y}C_{z};
where x is of from about 5 at. % to about 30 at. %;
where x+y is of from about 5 at. % to about 30 at. %; and
where z is of from about 0.005 at. % to about 4.1 at. %.

2. The magnetostrictive alloy of claim 1, wherein the source of C is pure carbon, a low carbon steel, a high carbon steel or mixtures thereof; and
wherein the source of Fe is pure iron, low carbon steel, high carbon steel or mixtures thereof.

3. The magnetostrictive alloy of claim 1, further including Bₐ;
where a is of from about 0.005 at. % to about 4.1 at. %.

4. The magnetostrictive alloy of claim 1, further including N_{b}.
where b is of from about 0.005 at. % to about 4.1 at. %.

5. The magnetostrictive alloy of claim 1, further including Bₐ and N_{b};
where a is of from about 0.005 at. % to about 4.1 at. %; and
where b is of from about 0.005 at. % to about 4.1 at. %.

6. A magnetostrictive alloy containing iron and gallium comprising:
Fe_{100-(x+y+z)}GaₓAl_{y}B_{z};
where x is of from about 5 at. % to about 30 at. %;
where x+y is of from about 5 at. % to about 30 at. %; and
where z is of from about 0.005 at. % to about 4.1 at. %.

7. The magnetostrictive alloy of claim 6, wherein the source of Fe is pure iron, low carbon steel, high carbon steel or mixtures thereof.

8. The magnetostrictive alloy of claim 6, further containing carbon.

9. A magnetostrictive alloy containing iron and gallium comprising:
Fe_{100-(x+y+z)}GaₓAl_{y}N_{z};
where x is of from about 5 at. % to about 30 at. %;
where x+y is of from about 5 at. % to about 30 at. %; and
where z is of from about 0.005 at. % to about 4.1 at. %.

10. The magnetostrictive alloy of claim 9, wherein the source of Fe is pure iron, low carbon steel, high carbon steel or mixtures thereof.

11. The magnetostrictive alloy of claim 9, further containing carbon.

12. The magnetostrictive alloy of claim 1, wherein x is of from about 17 at. % to about 22 at. %; y is of from about 0 to about 22 at. %, and x+y is of from about 17 at. % to about 22 at. %.
